(19) United States
(12) Patent Application Publication
(10) Pub. No.: US 2018/0072616 A1
(43) Pub. Date: Mar. 15, 2018

(54) GLASS PANEL INCLUDING A SUBSTRATE COATED WITH A STACK THAT INCLUDES AT LEAST ONE SILVER FUNCTIONAL LAYER

(71) Applicant: SAINT-GOBAIN GLASS FRANCE, Courbevoie (FR)

(72) Inventors: Sophie BROSSARD, Minneapolis, MN (US); Florent MARTIN, Minneapolis, MN (US)

(21) Appl. No.: 15/553,369

(22) PCT Filed: Feb. 24, 2016
(86) PCT No.: PCT/FR2016/050427

§ 371 Date: Aug. 24, 2017

(30) Foreign Application Priority Data
Feb. 25, 2015 (FR) 1551592

(51) Int. Cl. C03C 17/36; C03B 27/012

(52) U.S. Cl. CPC C03C 17/366; C03C 17/3626; C03C 17/3644; C03C 17/3649; C03C 17/3681; C03C 2218/156; C03C 2217/216; C03C 2217/24; C03C 2217/256; C03C 2217/261; C03C 2217/281; C03B 27/012

(57) ABSTRACT

A material includes a transparent substrate coated with a stack of thin layers including at least one silver-based functional metal layer, including a doping element, of thickness E formed from monocrystalline grains having a lateral dimension D, defined as a line along the grain edge. The D/E ratio is greater than 1.05.

The invention relates to a material such as a glazing comprising a transparent substrate coated with a stack of thin layers comprising at least one silver-based functional metal layer.

Silver-based functional metal layers (or silver layers) have advantageous electrical conduction and infrared radiation (IR) reflection properties, hence their use in “solar-control” glazing, targeted at reducing the amount of incoming solar energy, and/or in “low-emissivity” glazing, targeted at reducing the amount of energy-dissipated to the outside of a building or a vehicle.

These silver layers are deposited between coatings based on dielectric materials which generally comprise several dielectric layers making it possible to adjust the optical properties of the stack. These dielectric layers also make it possible to protect the silver layer from chemical or mechanical attacks.

The optical and electric properties of the glazings are directly dependent on the quality of the silver layers, such as:
their crystalline state; the silver layers comprise monocrystalline grains based on sliver,
their homogeneity,
their environment, such as the nature and the surface roughness at the interfaces above and below the silver layer.

In order to improve the quality of silver-based functional metal layers, it is known to use coatings based on dielectric materials comprising dielectric layers having a stabilizing function which are intended to promote the wetting and the nucleation of the silver layer.

The quality of the silver layer has an impact not only on the visual appearance but also on optical properties, especially the presence of haze, electrical conductivity and chemical resistance, especially the corrosion resistance of the stack.

The applicant has discovered that it is possible to improve the homogeneity of the silver layer, in terms of thickness, surface area and volume, by optimizing crystallization. Homogenization is obtained by controlling the distribution, shape and size of the monocrystalline grains of silver. Obtaining better homogenization has an influence on several properties, especially on the mechanical durability of the stacks, on the plasticity of the sliver layer but also on the electrical properties such as the sheet resistance.

The subject of the invention is a material comprising a transparent substrate coated with a stack of thin layers comprising at least one silver-based functional metal layer, comprising a doping element of thickness E formed from monocrystalline grains having a lateral dimension D, defined as a line along the grain edge, characterized in that the D/E ratio is greater than 1.05.

The invention also relates to a process for preparing a material comprising a transparent substrate coated with a stack of thin layers, according to which:
above the transparent substrate, at least one silver-based functional layer comprising a doping element over a thickness E is deposited, the functional layer is formed from monocrystalline grains having a lateral dimension d defined as a line along the grain edge, then
lateral growth of the grains is carried out, induced by diffusion of the doping elements leading to obtaining monocrystalline grains having a lateral dimension D, defined as a line along the grain edge, such that the D/E ratio is greater than 1.05.

The growth of the grains induced by diffusion of doping elements, or DIGM (diffusion induced grain boundary migration), is a known phenomenon in the field of metallurgy. However, the applicant has discovered that this growth technique is particularly beneficial when it is applied to silver-based functional layers which have the particular feature, due to their thinness, of being formed of monocrystalline columnar grains. “Columnar” is intended to mean the fact that the monocrystalline grains of silver are arranged such that there is essentially only one monocrystalline grain occupying the thickness of the silver layer at any point.

Doping of the silver-based metal layers with other elements enables increased and controlled growth of the silver-based monocrystalline grains during a heat treatment. Advantageously, the lateral growth of the grains induced by diffusion of the doping elements is carried out by a heat treatment of tempering or annealing type.

The silver-based functional metal layers included in stacks are deposited at thicknesses of less than 20 nm. The lateral dimension of the grains is generally of the order of the thickness. During a heat treatment, depending on the temperature and the duration, the lateral dimension of the grains increases, but only to a limited extent when the layer does not comprise doping elements. A heat treatment equivalent to tempering, for example of approximately 10 min at 620° C., thus produces an increase of approximately 45% of the mean size of the monocrystalline grains in the absence of doping element.

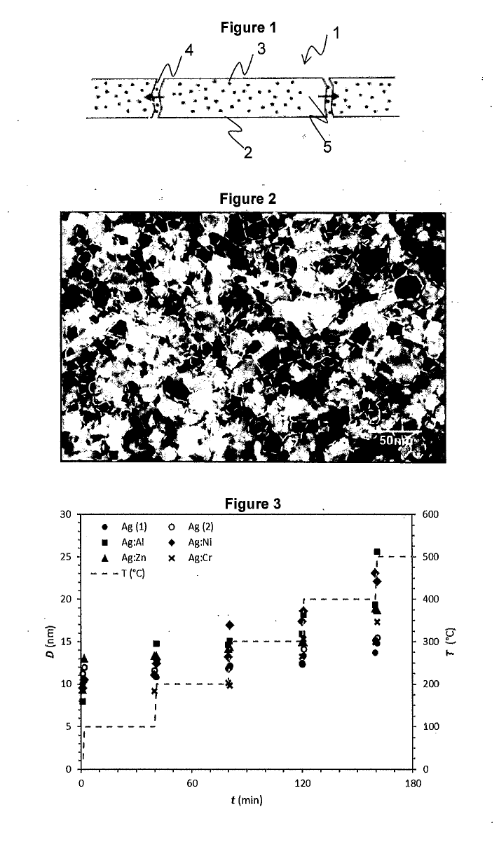

The growth of the grains induced by diffusion of doping elements occurs according to the diagram presented in FIG. 1. A layer of silver 1 comprises several monocrystalline grains 2 separated by grain boundaries 4. These monocrystalline grains 2 comprise doping elements 3 in solution. The rate of diffusion of the doping elements 3 depends on the temperature. For a “low” temperature, the doping elements 3 barely diffuse, or do not diffuse, whereas the grain boundaries 4 may, for their part, diffuse. When the grain boundaries 4 diffuse, they “sweep” a region of material represented by the two horizontal arrows. The doping elements 3 will then become concentrated in the grain boundaries 4, where their presence is less disruptive to the crystal network. The doping elements concentrated at the grain boundaries are then in a more energetically favorable position. This energy balance will then further favor the movement of the grain boundaries, and hence the lateral growth of the monocrystalline grains.

According to the invention, a lateral dimension (d or D) is defined as a line along the grain edge. “Line” (D or d) refers to a straight line segment joining two points of the contour of a grain. The lateral dimension of the grains may be measured by processing images obtained by any direct or indirect means of microscopic observation, such as scanning electron microscopy, transmission electron microscopy, electron backscatter diffraction, atomic force microscopy and optical microscopy.

“d” corresponds to the lateral dimension of the grains before lateral growth of the grains induced by diffusion of the doping elements, and “D” corresponds to the lateral dimension of the grains after lateral growth of the grains induced by diffusion of the doping elements.

According to the invention, the characteristic of D/E being greater than 1 is considered to be met when at least 80%, preferably at least 90%, better still at least 95% and even better still 100% of the grains have at least one lateral dimension D which satisfies this relation. To this end, the lateral dimension of 100 to 200 grains is measured manually.

Advantageously, the monocrystalline grain(s) have, in increasing order of preference, a lateral dimension D, defined as a line along the grain edge, on all the grains, of greater than 15 nm, greater than 16 nm, greater than 17 nm, greater than 18 nm, greater than 19 nm, greater than 20 nm and better still greater than 23 nm.

The lateral dimension D is preferably less than 300 nm, or even less than 200 nm, or better still less than 100 nm.

The D/E ratio is advantageously, in increasing order of preference, greater than 1.10, greater than 1.20, greater than 1.30, greater than 1.40, greater than 1.50 and better still greater than 1.60. The D/E ratio is preferably less than 10.

The stack is deposited by magnetic-field-assisted cathode sputtering (magnetron process). According to this advantageous embodiment, all the layers of the stack are deposited by magnetic-field-assisted cathode sputtering.

Unless indicated otherwise, the thicknesses alluded to in the present document are physical thicknesses and the layers are thin layers. Thin layer is intended to mean a layer with a thickness of between 0.1 nm and 100 micrometers.

Throughout the description, the substrate according to the invention is regarded as being positioned horizontally. The stack of thin layers is deposited above the substrate. The meaning of the expressions “above” and “below” and “lower” and “upper” is to be considered with respect to this orientation. Unless specifically stipulated, the expressions “above” and “below” do not necessarily mean that two layers and/or coatings are positioned in contact with one another. When it is specified that a layer is deposited “in contact” with another layer or with a coating, this means that there cannot be one or more layers inserted between these two layers.

A silver-based functional metal layer comprises at least 95.0%, preferably at least 96.5% and better still at least 97.0% by weight of silver relative to the weight of the functional layer. The silver-based functional metal layer preferably comprises less than 3.5% by weight of metals other than silver relative to the weight of the silver-based functional metal layer.

The limitation, according to which the silver-based functional metal layer comprises at least 95.0%, preferably at least 96.5% and better still at least 97.0% by weight of silver relative to the weight of the functional layer, means that the total weight of doping elements or impurities does not exceed 5.0%, preferably 3.5% and better still 3.0% of the weight of the functional layer.

The silver-based functional metal layers have a thickness E of less than 20 nm. The thickness of the silver-based functional layers is, in increasing order of preference, from 5 to 20 nm, from 8 to 15 nm.

The silver-based functional metal layers comprise a doping element. These layers may be obtained by cathode sputtering deposition, either from two targets, or from one silver target doped with the doping element. The doping element is preferably a metal chosen from aluminum, nickel, zinc or chromium.

The doping element is advantageously chosen from aluminum, nickel and zinc; even more advantageously, it is chosen from aluminum and nickel. Better still, it is aluminum.

The silver-based functional metal later may especially comprise 0.5 to 5.0% by weight of doping element relative to the weight of doping element and silver in the functional layer.

The silver-based functional metal layer may be doped with aluminum and optionally solely with aluminum. It comprises less than 1.0%, preferably less than 0.5%, or even less than 0.1% by weight of metals other than silver and aluminum relative to the weight of the sliver-based functional metal layer. When the doping element is aluminum, the proportions by weight thereof are from 1.0 to 4.0%, preferably from 1.5 to 3.5% relative to the weight of doping element and silver in the functional layer.

The silver-based functional metal layer may be doped with nickel and optionally solely with nickel. It comprises less than 1.0%, preferably less than 0.5%, or even less than 0.1% by weight of metals other than silver and nickel relative to the weight of the silver-based functional metal layer. When the doping element is nickel, the proportions by weight thereof are from 1.0 to 3.0%, preferably from 1.0 to 2.0% relative to the weight of doping element and silver in the functional layer.

The silver-based functional metal layer may be doped with zinc and optionally solely with zinc. It comprises less than 1.0%, preferably less than 0.5%, or even less than 0.1% by weight of metals other than silver and zinc relative to the weight of the silver-based functional metal layer.

The silver-based functional metal layer may be doped with chromium and optionally solely with chromium. It comprises less than 1.0%, preferably less than 0.5%, or even less than 0.1% by weight of metals other than silver and chromium relative to the weight of the silver-based functional metal layer.

The doping may be measured, for example, by Castaing microprobe analysis (electron probe microanalyser, EPMA).

The stack of thin layers advantageously comprises at least one silver-based functional metal layer and at least two coatings based on dielectric materials, each coating comprising at least one dielectric layer, such that each functional layer is arranged between two coatings based on dielectric materials.

The coatings based on dielectric materials have a thickness of greater than 15 nm, of between 15 and 50 nm or between 30 and 40 nm.

The dielectric layers of the coatings based on dielectric materials have the following characteristics, alone or in combination:
they are deposited by magnetic-field-assisted cathode sputtering;
they are chosen from dielectric layers with a barrier function or a stabilizing function, advantageously they are chosen from dielectric layers with a stabilizing function,
they are chosen from oxides or nitrides of one or more elements chosen from titanium, silicon, aluminum, tin and zinc,
they have a thickness of greater than 5 nm, preferably of between 8 and 35 nm.

“Dielectric layers with a barrier function” is intended to mean a layer made of a material which is able to form a barrier to the diffusion of oxygen and water at high temperature, originating from the ambient atmosphere or from the transparent substrate, towards the functional layer. The dielectric layers with a barrier function may be based on silicon and/or aluminum compounds chosen from oxides such as SiO₂, nitrides such as silicon nitride Si₃N₄ and aluminum nitrides AlN, and oxynitrides SiOₓN_{y}, optionally doped by means of at least one other element. The dielectric layers with a barrier function may also be based on zinc tin oxide.

“Dielectric layers with a stabilizing function” is intended to mean a layer made of a material which is able to stabilize the interface between the functional layer and said layer. The dielectric layers with a stabilizing function are preferably based on crystallized oxide, especially based on zinc oxide, optionally doped by means of at least one other element such as aluminum. The dielectric layer(s) with a stabilizing function are preferably zinc oxide layers.

The dielectric layer(s) with a stabilizing function may be located above and/or below, preferably below, at least one silver-based functional metal layer or each silver-based functional metal layer, either directly in contact therewith or separated by a blocking layer.

According to a particularly advantageous embodiment, the material according to the invention is characterized in that the stack of thin layers comprises at least one silver-based functional metal layer and at least two coatings based on dielectric materials, each coating comprising at least one dielectric layer, such that each silver-based functional metal layer is arranged between two coatings based on dielectric materials, said dielectric layer being chosen from dielectric layers with a barrier function or a stabilizing function. Said dielectric layer is particularly advantageously a dielectric layer with a stabilizing function, located below said silver-based functional layer. It is preferably based on zinc oxide, optionally doped by means of at least one other element. Advantageously, said element is aluminum.

According to an advantageous embodiment, the stack comprises a dielectric layer based on aluminum and/or silicon nitride located above at least one portion of the functional layer. The dielectric layer based on aluminum and/or silicon nitride has a thickness:
of less than or equal to 100 nm, less than or equal to 50 nm, or less than or equal to 40 nm, and/or
of greater than or equal to 15 nm, greater than or equal to 20 nm, or greater than or equal to 25 nm.

The stacks may also comprise blocking layers, the function of which is to protect the functional layers by preventing any degradation linked to the deposition of a coating based on dielectric materials or linked to a heat treatment. According to one embodiment, the stack comprises at least one blocking layer located below, and in contact with, a silver-based functional metal layer, and/or at least one blocking layer located above, and in contact with, a silver-based functional metal layer.

Among the blocking layers conventionally used, especially when the functional layer is a silver-based metal layer, mention may be made of blocking layers based on a metal chosen from niobium Nb, tantalum Ta, titanium Ti, chromium Cr or nickel Ni, or based on an alloy obtained from at least two of these metals, especially a nickel-chromium alloy (NiCr).

The thickness of each blocking layer is preferably:
at least 0.5 nm, or at least 0.8 nm, and/or
at most 5.0 nm, or at most 2.0 nm.

The stack may comprise an upper protective layer deposited as the last layer in the stack, especially in order to confer scratch resistance properties. The upper protective layers may be chosen from layers based on zirconium, zinc and/or titanium oxide. These layers have a thickness of between 2 and 5 nm.

An example of a suitable stack according to the invention comprises:
a coating based on dielectric materials located below the silver-based functional metal layer, the coating possibly comprising at least one dielectric layer based on aluminum and/or silicon nitride,
optionally a blocking layer,
a silver-based functional metal layer,
optionally a blocking layer,
a coating based on dielectric materials located above the silver-based functional metal layer, the coating possibly comprising at least one dielectric layer based on aluminum and/or silicon nitride,
an upper protective layer.

The transparent substrates according to the invention are preferably made of a rigid inorganic material such as glass, especially soda-lime-silica glass, or organic, based on polymers (or made of polymer).

The transparent organic substrates according to the invention may also be made of rigid or flexible polymer. Examples of suitable polymers according to the invention include, especially:
polyethylene,
polyesters, such as polyethylene terephthalate (PET), polybutylene terephthalate (PBT) or polyethylene naphthalate (PEN);
polyacrylates, such as polymethyl methacrylate (PMMA);
polycarbonates;
polyurethanes;
polyamides;
polyimides;
fluoropolymers, such as fluoroesters, for example ethylene-tetrafluoroethylene (ETFE), polyvinylidene fluoride (PVDF), polychlorotrifluoroethylene (PCTFE), ethylene-chlorotrifluoroethylene (ECTFE) or fluorinated ethylene-propylene copolymers (FEP);
photocrosslinkable and/or photopolymerizable resins, such as thiolene, polyurethane, urethane-acrylate or polyester-acrylate resins, and
polythiourethanes.

The thickness of the substrate generally varies between 0.5 mm and 19 mm. The thickness of the substrate is preferably less than or equal to 6 mm, or even 4 mm.

The invention also relates to the process for preparing the material according to the invention. According to this process, the stack of thin layers is deposited on the substrate by a vacuum technique such as cathode sputtering, optionally assisted by a magnetic field.

The lateral growth of the grains induced by diffusion of the doping elements is preferably carried out by a heat treatment. This heat treatment may be carried out at temperatures of between 350 and 800° C., preferably of between 500 and 700° C.

The heat treatment may especially be tempering carried out at a temperature of at least 500° C., preferably of at least 600° C.

The heat treatment may especially be annealing carried out at a temperature of between 200° C. and 550° C., or even between 350° C. and 500° C. for a duration preferably of at least one hour.

The material according to the invention, that is to say the transparent substrate coated with the stack defined above, may thus have undergone a heat treatment, said heat treatment being advantageously chosen from annealing, tempering and/or bending. Reference is then made to a heat-treated material. Advantageously, this is an annealed, tempered and/or bent material.

The material may be a monolithic glazing, a laminated glazing or a multiple glazing, especially a double glazing or a triple glazing.

### EXAMPLE

### I. Preparation of the Materials

Stacks of thin layers defined below are deposited on substrates made of clear soda-lime glass with a thickness of 2 mm.

For these examples, the conditions for deposition of the layers deposited by sputtering (“magnetron cathode” sputtering) are summarized in the table below.

The silver layer may be doped:
either by co-sputtering from two targets, a silver target and a doping element target,
or by sputtering from one silver target comprising the doping element.

During the deposition by co-sputtering from two targets, the two targets are placed inclined and powered up at the same time. The desired doping is obtained by adjusting the deposition powers. The deposition power of the silver target is fixed and the deposition power of the doping element target is varied.

Layers of silver doped with different doping elements and proportions of doping elements were tested. The layers of silver doped with zinc (Zn), chromium (Cr) and nickel (Ni) are obtained by co-sputtering from two targets. The layers of silver doped with aluminum are obtained by sputtering from a single target, already doped (Ag/Al target, doped to 3%).

In all the following examples, the composition of the layers, and especially the proportions of doping elements in the doped silver layer, were measured by conventional techniques of Castaing microprobe (electron probe microanalyser, EPMA). The concentration of doping element is expressed as weight of doping element relative to the weight of silver and of doping element.

TABLE 1

| | | Deposition | | |
|---|---|---|---|---|
| | Targets used | pressure | Gas | Index* |
| Si₃N₄ | Si:Al | 2 × 10⁻³ mbar | Ar 47% - N₂ 53% | 2.00 |
| | (9:8% by wt) | | | |
| ZnO | Zn:Al | 2 × 10⁻³ mbar | Ar 95% - O₂ 5% | 2.04 |
| | (98:2% by wt) | | | |
| NiCr | Ni:Cr | 2 × 10⁻³ mbar | Ar at 100% | — |
| | (80:20% at.) | | | |
| Ag | Ag | 8 × 10⁻³ mbar | Ar at 100% | — |
| Ag:Al | Ag:Al (3%) | 8 × 10⁻³ mbar | Ar at 100% | — |
| Ag:Ni | Ag and Ni | 8 × 10⁻³ mbar | Ar at 100% | — |
| Ag:Zn | Ag and Zn | 8 × 10⁻³ mbar | Ar at 100% | — |
| Ag:Cr | Ag and Cr | 8 × 10⁻³ mbar | Ar at 100% | — |

at.: atomic; wt: weight; *at 550 nm.

Different materials were prepared, comprising stacks which differ in terms of the nature of the silver-based functional layer and especially in terms of the presence and the nature of the doping element. The stacks comprise the following thin layers, defined starting from the substrate, according to the physical thicknesses in nanometers given:
a layer of aluminum-doped zinc oxide, of 5 nm
a layer of silver comprising, or not comprising, a doping element, 15 nm thick,
a layer of NiCr, of 0.5 nm, and
a layer of silicon nitride, of 5 nm.

The table below specifies, for each material tested, the nature and the proportions of doping elements.

Doping element

| Materials | Nature | Proportions |
|---|---|---|
| Cp.1 | — | 0% |
| Cp.2 | — | 0% |
| M.1 | Al | 3% |
| M.2 | Ni | 1.5% |
| M.3 | Zn | 1.9% |
| M.4 | Cr | 0.7% |

The lateral growth of the grains may be measured by transmission electron microscopy. FIG. 2 presents a bright field transmission electron micrograph of a substrate comprising a stack comprising at least one silver-based functional metal layer. In this figure, the grain boundaries have been redrawn with white dashed lines. The lateral dimension of the monocrystalline grains is determined by measuring this size on 100 to 200 grains.

FIG. 3 is a graph representing the change in the mean lateral dimension of the grains as a function of the temperature and the annealing time, for pure silver-based layers and for silver-based layers comprising a doping element. These results, summarized in the table below, are obtained:
by heating stacks comprising silver-based layers with and without doping element in situ in the transmission electron microscope,
by carrying out successive temperature steps every 100° C., and
by recording images after 1 and 40 minutes, each time.

| | | Cumulative treatment time (min) | | | | | | | | | |
|---|---|---|---|---|---|---|---|---|---|---|---|
| | | 0 | +1 | +40 | +1 | +40 | +1 | +40 | +1 | +40 | +1 |
| T (° C.) | | 0 | 100 | 100 | 200 | 200 | 300 | 300 | 400 | 400 | 500 |
| D* (nm) | Pure Ag (1) | 10.01 | — | — | 10.81 | 11.79 | 11.90 | 12.47 | 13.30 | 13.67 | 14.81 |
| | Pure Ag (2) | 11.23 | 11.97 | 11.58 | 12.88 | 11.82 | 12.17 | 12.33 | 14.09 | 15.14 | 15.47 |
| | Ag:Al (3%) | 7.94 | — | — | 14.70 | 14.58 | 15.03 | 15.91 | 18.15 | 19.31 | 25.55 |
| | Ag:Ni (1.5%) | 9.51 | 10.49 | 11.02 | 12.40 | 13.20 | 16.96 | 17.38 | 18.61 | 23.08 | 22.05 |
| | Ag:Zn (1.9%) | 9.31 | 13.03 | 13.31 | 13.33 | 14.15 | 14.37 | 14.90 | 14.90 | 18.86 | 18.69 |
| | Ag:Cr (0.7%) | 10.17 | 10.40 | 9.07 | 12.47 | 10.04 | 9.79 | 13.10 | 15.21 | 14.82 | 17.23 |

*Lateral dimension of the grains, mean measured over 100 to 200 grains.

The measurement of the change in the mean lateral dimension of the grains as a function of temperature, annealing time and doping element confirms that the addition of doping element makes it possible to obtain increased growth of the monocrystalline grains of silver. Indeed, the lateral growth of the grains induced by diffusion of doping elements, especially chosen from aluminum and nickel, makes it possible to obtain grains having a lateral dimension of approximately 25 nm. In comparison, a silver-based layer without doping element comprises grains having a lateral dimension generally of less than 15 nm.

This doping method makes it possible to obtain a silver-based layer with grains almost twice as large.

1. A material comprising a transparent substrate coated with a stack of thin layers comprising at least one silver-based functional metal layer, comprising a doping element, of thickness E formed from monocrystalline grains having a lateral dimension D, defined as a line along the grain edge, wherein the D/E ratio is greater than 1.05.

2. The material as claimed in claim 1, wherein the silver-based functional metal layer has a thickness E of less than 20 nm.

3. The material as claimed in claim 1, wherein the D/E ratio is greater than 1.30.

4. The material as claimed in claim 1, wherein the monocrystalline grains have a lateral dimension D, defined as a line along the grain edge, on all the grains, of greater than 15 nm.

5. The material as claimed in claim 1, wherein the doping element is a metal chosen from aluminum, nickel, zinc or chromium.

6. The material as claimed in claim 1, wherein the silver-based functional metal later comprises 0.5 to 5.0% by weight of doping element relative to the weight of doping element and silver in the functional layer.

7. The material as claimed in claim 1, wherein the doping element is (i) aluminum, the weight proportions of which are from 1.0 to 4.0% relative to the weight of doping element and silver in the functional layer, or (ii) nickel, the weight proportions of which are from 1.0 to 3.0% relative to the weight of doping element and silver in the functional layer.

8. The material as claimed in claim 1, wherein the stack of thin layers comprises at least one silver-based functional metal layer and at least two coatings based on dielectric materials, each coating comprising at least one dielectric layer, such that each silver-based functional metal layer is arranged between two coatings based on dielectric materials, said dielectric layer being chosen from dielectric layers with a barrier function or a stabilizing function.

9. The material as claimed in claim 8, wherein the dielectric layer is a dielectric layer with a stabilizing function, located below said silver-based functional layer.

10. The material as claimed in claim 9, wherein said dielectric layer with a stabilizing function is based on zinc oxide, which is optionally doped.

11. The material as claimed in claim 1, wherein the substrate is made of glass, or made of polymer.

12. The material as claimed in claim 1, having undergone a heat treatment.

13. The material as claimed in claim 12, wherein the heat treatment is chosen from annealing, tempering and/or bending.

14. A process for preparing a material comprising a transparent substrate coated with a stack of thin layers, the process comprising:
above said transparent substrate, depositing at least said silver-based functional layer comprising a doping element over a thickness E, said functional layer being formed from monocrystalline grains having a lateral dimension d defined as a line along the grain edge, then
carrying out lateral growth of the grains, induced by diffusion of the doping elements leading to obtaining monocrystalline grains having a lateral dimension D, defined as a line along the grain edge, such that the D/E ratio is greater than 1.05.

15. The process for preparing a material as claimed in claim 14, wherein the lateral growth of the grains induced by diffusion of the doping elements is carried out by a heat treatment.

16. The process for preparing a material as claimed in claim 15, wherein the heat treatment is carried out at temperatures of between 350 and 800° C.

17. The process for preparing a material as claimed in claim 15, wherein the heat treatment is tempering carried out at a temperature of at least 500° C.

18. The process for preparing a material as claimed in claim 15, wherein the heat treatment is annealing that is carried out at a temperature of between 350° C. and 550° C. for a duration of at least one hour.

19. The material as claimed in claim 4, wherein the lateral dimension D is greater than 20 nm.

20. The material as claimed in claim 11, wherein the glass is soda-lime-silica glass.

21. The material as claimed in claim 11, wherein the polymer is polyethylene, polyethylene terephthalate or polyethylene naphthalate.

22. The process for preparing a material as claimed in claim 16, wherein the heat treatment is carried out at temperatures of between 500 and 700° C.

23. The process for preparing a material as claimed in claim 17, wherein the heat treatment is tempering carried out at a temperature of at least 600° C.
